(19) United States
(12) Patent Application Publication
(10) Pub. No.: US 2014/0188778 A1
(43) Pub. Date: Jul. 3, 2014

(54) Computer-Implemented System for Detecting Anomaly Conditions in a Fleet of Assets and Method of Using the Same

(71) Applicant: GENERAL ELECTRIC COMPANY, Schenectady, NY (US)

(72) Inventors: Dustin Ross Garvey, Albany, NY (US); Feng Xue, Clifton Park, NY (US)

(73) Assignee: GENERAL ELECTRIC COMPANY, Schenectady, NY (US)

(21) Appl. No.: 13/728,721

(22) Filed: Dec. 27, 2012

(51) Int. Cl. G06N 5/02

(52) U.S. Cl. CPC G06N 5/02
USPC 706/50

(57) ABSTRACT

A system for determining anomaly conditions within a fleet of physical assets includes a central system having at least one computing device, the computing device including a processor and a memory device coupled to the processor and a database associated with the central system. The system includes a plurality of databases and a plurality of client devices associated with the fleet of physical assets. The system is configured to receive a first set of fleet data. The system is further configured to generate one or more computer-executable steps for detection of predicted anomalies. The system is configured to receive a first set of fleet asset data. The system is configured to detect at least one physical asset from the fleet of physical assets predicted to have at least one anomaly using the one or more computer-executable steps for detection of predicted anomalies and the first set of fleet asset data.

### BACKGROUND

The field of the invention relates generally to computer-implemented programs and, more particularly, to a computer-implemented system for detecting anomaly conditions in a fleet of assets and method of using the same.

Known fleets of assets are characterized as a group of assets where each component asset is substantially similar to the other assets in the fleet with regard to several characteristics including asset type, name, design, manufacturing conditions, and age. It is often convenient to administer physical assets in an organization in terms of fleets because these substantial similarities often allow for similar approaches to diagnosis, repair, maintenance, and replacement of parts or assets.

Known considerations regarding monitoring and maintaining a fleet of assets include a need for a method of detecting anomalies in the assets. Put differently, it is important to note when the condition of an individual asset in the fleet have shifted from the normal condition associated with an asset of similar characteristics. Anomaly conditions may indicate that an asset requires service, repair, or replacement. Failure to detect anomaly conditions may increase the cost of managing a fleet of assets.

Most known approaches to anomaly detection require the development of a model that is trained on particular individual assets. Training a model, in this context, refers to adjusting the model so that it factors in the unique relationship that each fleet has between the characteristics and the conditions of fleet assets.

Although training a model for anomaly detection using individual assets is possible in small and/or localized fleets, it becomes more difficult when the fleet size is large and/or distributed. Also, as the fleets mature, such models for anomaly detection may often need to be refined. Such a need to iterate the model will compound the problems posed by large and/or distributed fleets. Even small and/or localized fleets can incur significant operational and financial expenses when iterating a model repeatedly.

### BRIEF DESCRIPTION

In one aspect, a network-based system for determining anomaly conditions within a fleet of physical assets is provided. The network-based system includes a central system having at least one computing device. The computing device includes a processor and a memory device coupled to the processor. The network-based system also includes a database associated with the central system. The network-based system further includes a plurality of databases associated with the fleet of physical assets. The network-based system additionally includes a plurality of client devices associated with the fleet of physical assets. The network-based system is configured to receive, at the central system, a first set of fleet data from at least one data repository. The first set of fleet data is substantially representative of fleet asset condition signals that are substantially representative of conditions associated with the fleet of physical assets. The network-based system is also configured to generate, at the central system, using the first set of fleet data, one or more computer-executable steps for detection of predicted anomalies for each asset of the fleet of physical assets. The network-based system is further configured to receive, at the central system, a first set of fleet asset data from the at least one data repository. The first set of fleet asset data is substantially representative of individual asset condition signals associated with the fleet of physical assets. The network-based system is additionally configured to detect at least one physical asset from the fleet of physical assets predicted to have at least one anomaly using the one or more computer-executable steps for detection of predicted anomalies and the first set of fleet asset data.

In a further aspect, a computer-implemented method for determining anomaly conditions within a fleet of physical assets is provided. The method is performed by a central system having at least one computing device. The computing device includes a processor and a memory device coupled to the processor. The method includes receiving a first set of fleet data from at least one data repository. The first set of fleet data is substantially representative of fleet asset condition signals that are substantially representative of conditions associated with the fleet of physical assets. The method also includes generating one or more computer-executable steps for detection of predicted anomalies for each asset of the fleet of physical assets using the first set of fleet data. The method further includes receiving a first set of fleet asset data from the at least one data repository. The first set of fleet asset data is substantially representative of individual asset condition signals associated with a particular asset associated with the fleet of physical assets. The method additionally includes detecting at least one physical asset from the fleet of physical assets predicted to have at least one anomaly using the one or more computer-executable steps for detection of predicted anomalies and the first set of fleet asset data.

In another aspect, a computer for determining anomaly conditions within a fleet of physical assets is provided. The computer is associated with a database. The computer also includes a processor and a memory device coupled to the processor. The processor is programmed to receive a first set of fleet data from at least one data repository. The first set of fleet data is substantially representative of fleet asset condition signals which are substantially representative of conditions associated with the fleet of physical assets. The processor is also programmed to generate one or more computer-executable steps for detection of predicted anomalies for each asset of the fleet of physical assets. The processor is further programmed to receive a first set of fleet asset data from at least one data repository. The first set of fleet asset data is substantially representative of state signals associated with a particular asset associated with the fleet of physical assets. The processor is additionally programmed to detect at least one physical asset from the fleet of physical assets predicted to have at least one anomaly using the one or more computer-executable steps for detection of predicted anomalies and the first set of fleet asset data.

### DRAWINGS

These and other features, aspects, and advantages will become better understood when the following detailed description is read with reference to the accompanying drawings in which like characters represent like parts throughout the drawings, wherein:

FIG. 1 is a schematic view of an exemplary high-level network-based system for determining anomaly conditions within a fleet of physical assets;

FIG. 2 is a block diagram of an exemplary computing device known as a central system that may be used with the network-based system shown in FIG. 1;

FIG. 3 is a flow chart of an exemplary process for training the network-based system, shown in FIG. 1, to determine anomaly conditions within a fleet of physical assets;

FIG. 4 is flow chart of an exemplary process for evaluating a fleet of assets using the network-based system shown in FIG. 1; and

FIG. 5 is a simplified flow chart of the overall process for training and evaluating a network-based system, shown in FIG. 1, to determine anomaly conditions within a fleet of physical assets as shown in FIG. 3 and FIG. 4.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, the terms “software” and “firmware” are interchangeable, and include any computer program stored in memory for execution by devices that include, without limitation, mobile devices, clusters, personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “fleet” and related terms, e.g., “fleet of physical assets,” refers to a grouping of assets that have at least one substantially similar characteristic such that the substantially similar characteristic makes it efficient to manage the grouping of assets together. Substantially similar characteristics may include, without limitation, asset type, asset model, asset age, asset manufacturer, asset location, asset function, asset owner, and asset value. Also, as used herein, fleets of physical assets are monitored to find a given physical asset which is anomalous with respect to the fleet.

As used herein, the term “anomaly” and related terms, e.g., “anomalies,” refers to an object or event that does not conform to the expectation for a group of assets of a similar type. Not conforming to expectations may include, without limitation, premature wearing of the physical structure of an asset, inefficient function of an asset, improper function of an asset, and erratic function of an asset. Also, as used herein, anomalies are detected within a physical asset with respect to the fleet of physical assets.

As used herein, the term “client device” and related terms, e.g., “asset client device”, refer to devices that can access services at a network-connected server using a client-server architecture. Such client devices may be any computing device with hardware and software that can enable such access to the services of a network-connected server including, without limitation, laptop computers, desktop computers, personal digital assistants, tablet computers, and smart-phones. Also, as used herein, client devices facilitate interactions between the central system and the fleet of physical assets.

As used herein, the term “signal” and related terms, e.g., “signals,” refers to a type of measurement data that is sensed by a sensor or a plurality of sensors on an asset within the fleet of physical assets. The signals may include, without limitation, data on the mechanical integrity of a component, data on the mechanical operation of a component, data on the chemical state of a component, data on the electrical conductivity of a component, data on the radiation signatures of a component, and data on the temperature of a component. Also, as used herein, signal data facilitates predicting an anomaly in a fleet asset based upon the deviation from the expected signal data for the fleet of physical assets.

As used herein, the term “data warehouse” and related terms, e.g., “data warehouse transformation”, refers to a centralized data storage facility that receives data from multiple separate data storage facilities. Data warehouses utilize one or a variety of methods to transform the received data to a standard format. These methods may include, without limitation, methods of extraction, loading, and transformation, methods of data normalization, and methods that utilize defined data structures to dynamically alter data types. Also, as used herein, data warehouses facilitate activities that include, without limitation, centralization of asset data to improve data access and efficiency of data processing.

As used herein, the term “cloud computing” and related terms, e.g., “cloud computing architecture”, refer to computer architecture that utilizes multiple computer systems, networks, data storage devices, and database systems for processing scalability, data access, and high-availability computer services. Central to the definition of cloud computing, and distinguishing it from other computer architectures including distributed computing, are the notions that no single computer system, network, data storage device, and/or database system is essential to the architecture, and that cloud computing assets need not be standardized, e.g., to use the same operating system. Cloud computing architecture is designed to allow for the possibility of a variety of components of a cloud computing architecture to enter or leave the architecture at any time or be provisioned for new purposes or in new manners. Generally, cloud computing architecture facilitates highly flexible computer architectures. Cloud computing is a developing area of computer architecture and some specific approaches may evolve. Also, as used herein, cloud computing encompasses architectural approaches known as cloud computing today and in the future. Further, as used herein, cloud computing facilitates activities that include, without limitation, centralizing data into a data warehouse, high-performance analysis of fleet assets, and enabling cloud-based services used by client devices associated with the fleet of physical assets.

As used herein, the term “distributed computing” and related terms, e.g., “distributed computing architecture”, refer to computer architecture that utilizes multiple computer systems, networks, and database systems for processing scalability, data access, and high-availability computer services. Although sometimes used synonymously, distributed computing can be distinguished from cloud computing due to a less flexible design. Generally, distributed computing architectures assume a known and fixed amount of components of known types. Also, as cloud computing and distributed computing are used, sometimes, synonymously, the embodiments represented herein that utilize one architecture may also be understood to utilize the alternative architecture.

As used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

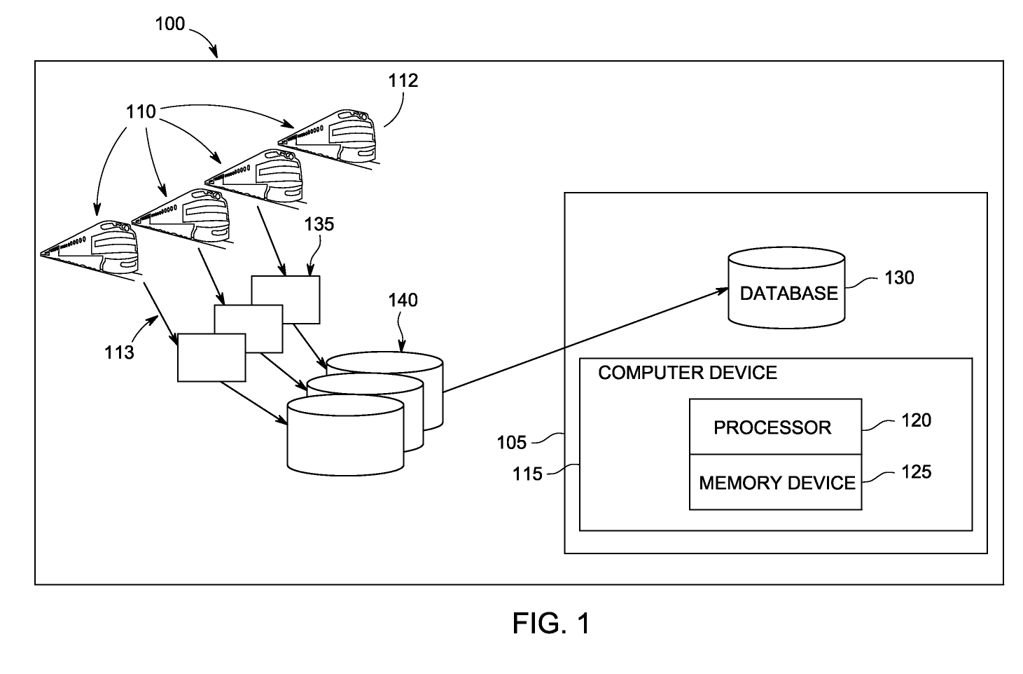

FIG. 1 is a schematic view of an exemplary high-level network-based system 100 for determining anomaly conditions within a fleet of physical assets 110. In the exemplary embodiment, fleet of physical assets 110 is a fleet of locomotives. In alternative embodiments, fleet of physical assets 110 may include, without limitation, a fleet of vehicles, a fleet of transportation systems, a fleet of communication devices, a fleet of computing devices, a fleet of manufacturing devices, or any other fleet of devices capable of being used with network-based system 100.

Network-based system 100 includes a central system 105 having at least one computing device 115. Computing device 115 includes a processor 120 and further includes a memory device 125 coupled to processor 120. In alternative embodiments, computing device 115 includes a plurality of processors 120 and a plurality of memory devices 125. Central system 105 is associated with a database 130. In the exemplary embodiment, database 130 is a data warehouse manifested as one database instance. In alternative embodiments, database 130 is a data warehouse manifested as a plurality of database instances.

Database 130 is associated with a plurality of client databases 140. Client databases 140 are also associated with a plurality of client devices 135. Further, database 130 and central system 105 are capable of communicating with client databases 140 and client devices 135. Client devices 135 are associated with fleet of physical assets 110. Fleet of physical assets 110 is composed of individual assets 112.

In operation, fleet of physical assets 110 and individual assets 112 which compose fleet 110 send signal data 113 to plurality of client devices 135. In the exemplary embodiment, fleet of physical assets 110 create and send signal data 113 to client devices 135. In alternative embodiments, fleet of physical assets 110 create signal data 113 which is manually entered into client devices 135 or other devices and transmitted to central system 105. Further, client devices 135 send signal data 113 to client databases 140. In alternative embodiments, client devices 135 send signal data 113 directly to at least one of central system 105, computing device 115, database 130, and client databases 140.

In the exemplary embodiment, signal data 113 is substantially representative of at least one of a plurality of signal states (not shown) associated with detecting an anomaly in fleet of physical assets 110. Signal data 113 is vibration data from bearings in locomotives representing individual assets 112 in fleet of physical assets 110. In alternative embodiments, signal data 113 received by central system 105 includes, without limitation, data on the mechanical integrity of asset 112, and data on the mechanical operation of asset 112. Also, in other alternative embodiments, signal data 113 may include, without limitation, data on the corrosion of asset 112, data on the electrical conductivity of asset 112, and thermal data for asset 112.

In the exemplary embodiment, central system 105 includes one computing device 115. In alternative embodiments, central system 105 may include a plurality of computing devices 115. In some alternative embodiments, central system 105 may use a distributed computing architecture with plurality of computing devices 115. In other alternative embodiments, central system 105 may use a cloud-based architecture with other devices including, without limitation, client devices 135. In such embodiments, central system 105 uses some portion of computational ability of client devices 135 for the methods and algorithms described herein.

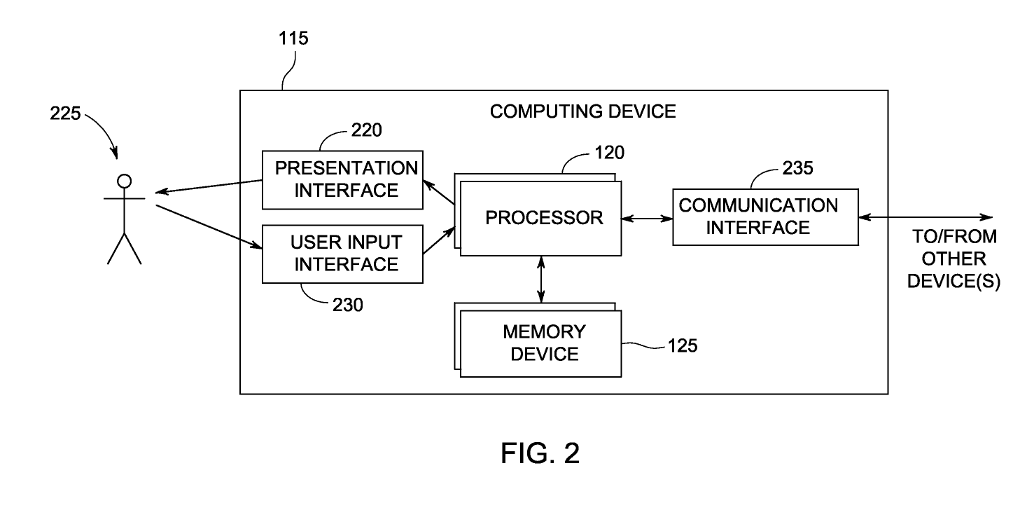

FIG. 2 is a block diagram of computing device 115 that may be used with network-based system 100 to determine anomaly conditions within fleet of physical assets 110 (both shown in FIG. 1). Computing device 115 includes a memory device 125 and a processor 120 operatively coupled to memory device 125 for executing instructions. In the exemplary embodiment, computing device 115 includes a single processor 120 and a single memory device 125. In alternative embodiments, computing device 115 may include a plurality of processors 120 and/or a plurality of memory devices 125. In some embodiments, executable instructions are stored in memory device 125. Computing device 115 is configurable to perform one or more operations described herein by programming processor 120. For example, processor 120 may be programmed by encoding an operation as one or more executable instructions and providing the executable instructions in memory device 125.

In the exemplary embodiment, memory device 125 is one or more devices that enable storage and retrieval of information such as executable instructions and/or other data. Memory device 125 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Memory device 125 may be configured to store operational data including, without limitation, signal data 113 (shown in FIG. 1), and/or any other type of data. In some embodiments, processor 120 removes or “purges” data from memory device 125 based on the age of the data. For example, processor 120 may overwrite previously recorded and stored data associated with a subsequent time and/or event. In addition, or alternatively, processor 120 may remove data that exceeds a predetermined time interval. Also, memory device 125 includes, without limitation, sufficient data, algorithms, and commands to facilitate operation of system 100.

In some embodiments, computing device 115 includes a user input interface 230. In the exemplary embodiment, user input interface 230 is coupled to processor 120 and receives input from user 225. User input interface 230 may include, without limitation, a keyboard, a pointing device, a mouse, a stylus, a touch sensitive panel, including, e.g., without limitation, a touch pad or a touch screen, and/or an audio input interface, including, e.g., without limitation, a microphone. A single component, such as a touch screen, may function as both a display device of presentation interface 220 and user input interface 230.

A communication interface 235 is coupled to processor 120 and is configured to be coupled in communication with one or more other devices, such as a sensor or another computing device 115, and to perform input and output operations with respect to such devices. For example, communication interface 235 may include, without limitation, a wired network adapter, a wireless network adapter, a mobile telecommunications adapter, a serial communication adapter, and/or a parallel communication adapter. Communication interface 235 may receive data from and/or transmit data to one or more remote devices. For example, a communication interface 235 of one computing device 115 may transmit an alarm to communication interface 235 of another computing device 115. Communications interface 235 facilitates machine-to-machine communications, i.e., acts as a machine-to-machine interface.

Presentation interface 220 and/or communication interface 235 are both capable of providing information suitable for use with the methods described herein, e.g., to user 225 or another device. Accordingly, presentation interface 220 and communication interface 235 may be referred to as output devices. Similarly, user input interface 230 and communication interface 235 are capable of receiving information suitable for use with the methods described herein and may be referred to as input devices.

In the exemplary embodiment, user 225 may use computing device 115 by receiving information on signal data 113 and fleet anomaly conditions (not shown) via presentation interface 220. User 225 may act on the information presented and use computing device 115 to control or communicate with fleet of physical assets 110. User 225 may initiate such an action via user input interface 230 which processes the user command at processor 120 and uses communication interface 235 to communicate with other devices. These other devices may include, without limitation, client devices 135 (shown in FIG. 1) associated with fleet of physical assets 110.

In the exemplary embodiment, computing device 115 is an exemplary embodiment of central system 105 (shown in FIG. 1). In at least some other embodiments, computing device 115 is also an exemplary embodiment of client devices 135. In most embodiments, computing device 115 at least illustrates the primary design of client devices 135.

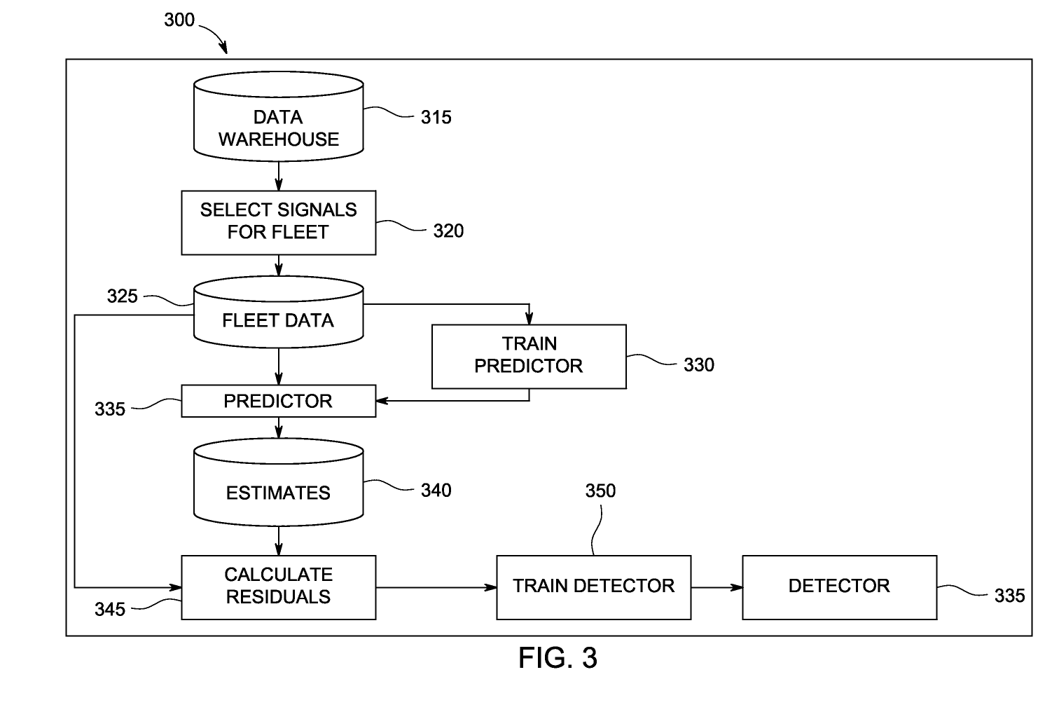

FIG. 3 is a flow chart of an exemplary process 300 for training network-based system 100 (shown in FIG. 1) to determine anomaly conditions within fleet of physical assets 110 (shown in FIG. 1). Signals 113 (shown in FIG. 1) are selected 320 for fleet 110 from data warehouse 315. In the exemplary embodiment, data warehouse 315 is database 130 (shown in FIG. 1) containing data from client databases 140 (shown in FIG. 1). In alternative embodiments, data warehouse 315 represents data stored at memory device 125 (shown in FIG. 1). Also, in the exemplary embodiment, signals selected 320 represent signal data generated from fleet of physical assets 110 and stored in at least one of client databases 140, database 130, and memory device 125.

Further, selecting 320 signals 113 for fleet 110 includes creating fleet data 325. Fleet data 325 represents signal data 113 from fleet of physical assets 110 that are constrained by selecting signals for fleet 320. As a subset of signal data 113, fleet data 325 is at least one type or a combination of types of signal data 113.

In at least some embodiments, signals 113 that are selected 320 for fleet 110 from data warehouse 315 includes an incomplete set of signals 113. In these at least some embodiments, selecting 320 signals 113 further includes generating estimated fleet data (not shown) and incorporating estimated fleet data (not shown) into fleet data 325.

Moreover, fleet data 325 is used to train 330 a predictor 335. Predictor 330 represents a computer-based program for predicting, based upon fleet data 325, future signal data (not shown) for fleet of physical assets 110 based upon fleet data 325. Future signal data represents signal data 113 that may be derived from fleet data 325 through the use of models and algorithms applied against fleet data 325 by predictor 335.

Additionally, in the exemplary process, predictor 335 is used to create estimates 340 based upon fleet data 325. In the exemplary embodiment, estimates 340 represent predicted future signal data created by predictor 335 when fleet data 325 is used as an input. In alternative embodiments, estimates 340 may also represent predicted future signal data created by predictor 335 when fleet data 325 and supplemental data is used as an input. Supplemental data includes, without limitation, user generated data (not shown) and approximated data (not shown) for physical assets 112 (shown in FIG. 1) which have incomplete fleet data 325 associated.

Furthermore, fleet data 325 is then compared to estimates 340 generated by predictor 335 using fleet data 325 to calculate residuals 345. In the exemplary embodiment, calculated residuals 345 represent the differences between estimates 340 and output available from fleet data 325.

Also, calculated residuals 345, estimates 340, and fleet data 325 are used to train 350 a detector 355. In the exemplary embodiment, detector 355 is used to determine, based upon individual data (not shown in FIG. 3), the presence of an anomaly condition in at least one asset 112 of fleet of physical assets 110. Further, training 350 represents applying a plurality of methods to create a predictive model (not shown) for the presence of an anomaly when individual data is used as an input.

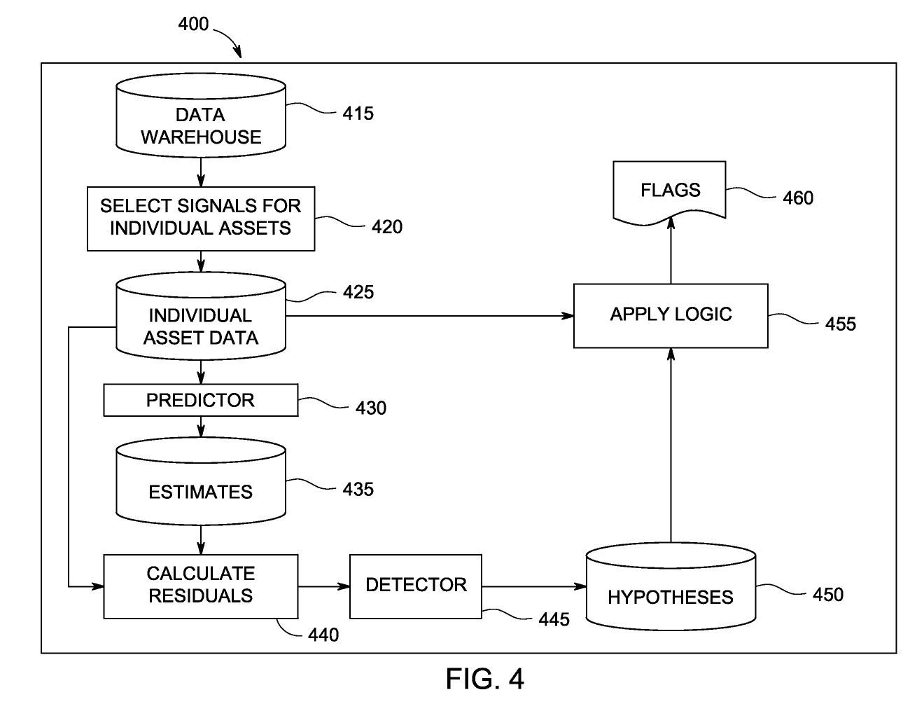

FIG. 4 is flow chart of an exemplary process 400 for evaluating fleet of assets 110 (shown in FIG. 1) using network-based system 100 (shown in FIG. 1). Signals are selected 420 for individual assets 112 (shown in FIG. 1) from a data warehouse 415. In the exemplary embodiment, data warehouse 415 is database 130 (shown in FIG. 1) containing data from client databases 140 (shown in FIG. 1). In alternative embodiments, data warehouse 415 represents data stored at memory device 125 (shown in FIG. 1).

Furthermore, in the exemplary embodiment, signals selected 420 represents signal data 113 (shown in FIG. 1) generated from individual assets 112 and stored at least one of client databases 140, database 130, and memory device 125. In contrast to selecting 320 (shown in FIG. 3) signals for a fleet of physical assets 110, selecting signals 420 results in individual data 425 where individual data 425 is unique and separate for each asset 112.

Individual data 425 is used with predictor 430 to create estimates 435. Predictor 430 represents predictor 335 (shown in FIG. 3) trained 330 (shown in FIG. 3) using fleet data 325 (shown in FIG. 3). In alternative embodiments, predictor 430 represents predictor 335 with modifications based upon user input (not shown) or artificial intelligence (not shown).

Estimates 435 are compared to individual data 425 to calculate residuals 440 for individual assets 112. In the exemplary embodiment, calculated residuals 440 represent differentials between estimates 435 and individual data 425.

Detector 445 is applied to calculated residuals 440, estimates 435, and individual data 425. Moreover, in the exemplary embodiment, detector 445 represents detector 355 (shown in FIG. 3) trained 350 (shown in FIG. 3) using fleet data 325. In alternative embodiments, detector 445 includes modifications based upon user input (not shown) or artificial intelligence.

Detector 445 creates at least one hypothesis 450 based upon calculated residuals 440, estimates 435, and individual data 425. In the exemplary embodiment, at least one hypothesis 450 represents a hypothesis of whether an individual asset 112 is anomalous, normal, or indeterminate with respect to fleet of physical assets 110.

Logic is applied 455 to at least one hypothesis 450 in conjunction with individual data 425. In the exemplary embodiment, logic represents at least one algorithm for determining whether an individual asset 112 is anomalous with respect to fleet of physical assets 110. In at least some embodiments, logic applied 450 includes applying an expert user model (not shown). In other embodiments, logic applied 450 includes applying machine learning (not shown).

At least one individual asset 112 is flagged 460. In the exemplary embodiment, flagging 460 represents identifying at least one individual asset 112 as anomalous with respect to fleet of physical assets 110.

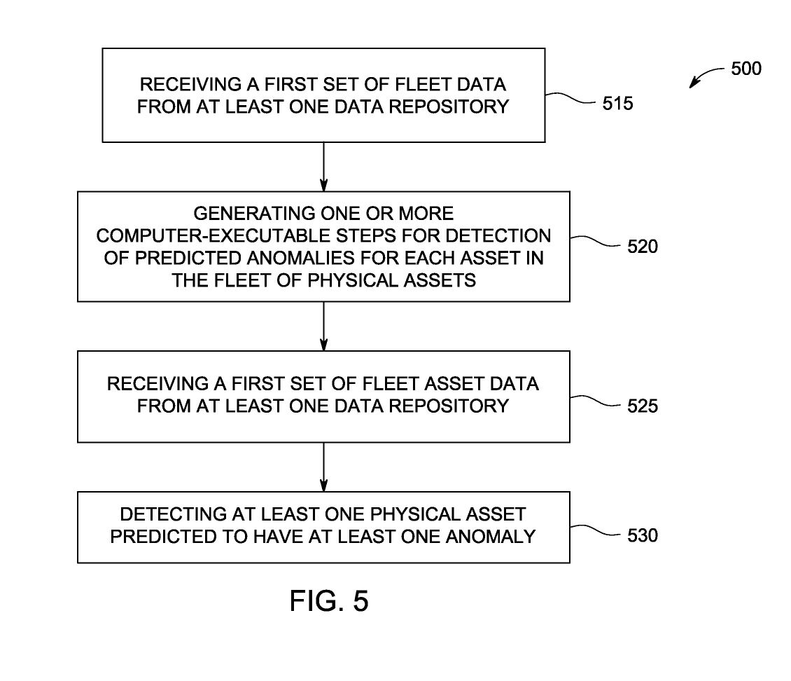

FIG. 5 is a simplified flow chart of the overall method 500 for training and evaluating a network-based system 100 (shown in FIG. 1) for determining anomaly conditions within fleet of physical assets 110 (shown in FIG. 1).

Method 500 for training and evaluating network-based system 100 includes receiving 515 a first set of fleet data from at least one data repository. In the exemplary embodiment, a first set of fleet data represents fleet data 325 (shown in FIG. 3) obtained from data warehouse 315 (shown in FIG. 3) by selecting signals for fleet 320 (shown in FIG. 3). At least one data repository is represented by at least one of client databases 140 (shown in FIG. 1), database 130 (shown in FIG. 1), and memory device 125 (shown in FIG. 1).

Further, method 500 includes generating 520 one or more computer-executable steps for detection of predicted anomalies for each asset 112 (shown in FIG. 1) in fleet of physical assets 110. In the exemplary embodiment, generating 520 one or more computer-executable steps for detection of predicted anomalies represents training 350 (shown in FIG. 3) detector 355 (shown in FIG. 3) of predicted anomalies for each asset 112 in fleet of physical assets 110.

Additionally, method 500 includes receiving 525 a first set of fleet asset data from at least one data repository. In the exemplary embodiment, receiving 525 a first set of fleet asset data represents receiving individual data 425 (shown in FIG. 4) obtained from data warehouse 415 (shown in FIG. 4) by selecting signals for individuals 420 (shown in FIG. 4). Receiving 525 a first set of fleet data further represents receiving individual data 425 associated with individual asset 112 and stored in at least one of client databases 140, database 130, and memory device 125.

Furthermore, method 500 includes detecting 530 at least one physical asset 112 predicted to have at least one anomaly. In the exemplary embodiment, detecting 530 represents using detector 445 (shown in FIG. 4), creating hypotheses 450 (shown in FIG. 4), applying logic 455 (shown in FIG. 4), and flagging 460 (shown in FIG. 4) at least one physical asset 112 predicted to have at least one anomaly.

The computer-implemented systems and methods as described herein provide an efficient approach for detecting anomalies in a fleet of physical assets. The embodiments described herein facilitate creating a robust detection method for identifying anomalous assets within a fleet of assets based upon signal data received from these assets. Also, the methods and systems described herein facilitate the training and use of a detection method for anomalies in assets of a fleet of physical assets with minimal customization for a particular type of fleet. Further, the methods and systems described herein will reduce the cost of managing a fleet of assets due to reduced time to train models for anomaly detection for a particular type of asset. Additionally, these methods and systems will enhance the overall ability to detect anomalies by allowing for iteration of detection methods without significant human intervention through the use of a retrained predictor and a retrained detector. Furthermore, the methods and systems described herein will reduce the operational, logistical, and financial costs associated with the management of a fleet of assets by improving anomaly detection and reducing the costs associated with creating and customizing anomaly detection systems.

An exemplary technical effect of the methods and computer-implemented systems described herein includes at least one of (a) reducing the financial and logistical search costs of managing a fleet of physical assets by detecting anomalous assets efficiently; (b) enhancing performance of fleet of physical assets by targeting anomalous assets with minimal customized training; and (c) reducing delays in service caused by anomalies in fleet of physical assets through effective and robust anomaly detection.

Exemplary embodiments of computer-implemented systems for determining anomaly conditions within a fleet of physical assets are described above in detail. The computer-implemented systems and methods of operating such systems are not limited to the specific embodiments described herein, but rather, components of systems and/or steps of the methods may be utilized independently and separately from other components and/or steps described herein. For example, the methods may also be used in combination with other enterprise systems and methods, and are not limited to practice with only the systems and methods for determining anomaly conditions with a fleet of physical assets described herein. Rather, the exemplary embodiment can be implemented and utilized in connection with many other enterprise applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A network-based system for determining anomaly conditions within a fleet of physical assets, said system comprising:
a central system having at least one computing device, said computing device including a processor and a memory device coupled to said processor;
a database associated with said central system;
a plurality of databases associated with the fleet of physical assets; and
a plurality of client devices associated with the fleet of physical assets, said network-based system configured to:
receive, at the central system, a first set of fleet data from at least one data repository, the first set of fleet data substantially representative of fleet asset condition signals that are substantially representative of conditions associated with the fleet of physical assets;
generate, at the central system, using the first set of fleet data, one or more computer-executable steps for detection of predicted anomalies for each asset of the fleet of physical assets;
receive, at the central system, a first set of fleet asset data from the at least one data repository, the first set of fleet asset data substantially representative of individual asset condition signals associated with a particular asset associated with the fleet of physical assets; and
detect, at the central system, using the one or more computer-executable steps for detection of predicted anomalies and the first set of fleet asset data, at least one physical asset from the fleet of physical assets predicted to have at least one anomaly.

2. A network-based system in accordance with claim 1, wherein said fleet asset condition signals are substantially representative of at least one of a plurality of signal states associated with detecting an anomaly in the fleet of physical assets.

3. A network-based system in accordance with claim 1, wherein said system is further configured such that receiving a first set of fleet data comprises:
receiving a first set of fleet data at the central system from the at least one data repository wherein the received first set of fleet data is one of incomplete or partially complete;
generating estimated fleet data comprises estimating the fleet data not received based upon previously received fleet data; and
incorporating the estimated fleet data with the received fleet data.

4. A network-based system in accordance with claim 1, wherein said system is further configured such that generating one or more computer-executable steps for detection of predicted anomalies comprises:
selecting, at the central system, a plurality of categories of state signals associated with an anomaly associated with a physical asset;
creating, at the central system, a trained predictor, the trained predictor substantially representative of a method of determining a future set of state signals based upon a present set of state signals for each asset in the fleet of physical assets; and
generating, at the central system, using the trained predictor and the first set of fleet data, the future set of state signals based upon the present set of state signals for a physical asset.

5. A network-based system in accordance with claim 1, wherein said system is further configured such that generating a method for detection of predicted anomalies further comprises:
creating, at the central system, a detector, the detector substantially representative of a method of identifying, based upon the future set of state signals, assets predicted to be anomalous, normal, or indeterminate; and
configuring the detector, at the central system, configuring the detector substantially representative of processing present set of state signals and future set of state signals for each asset of the fleet of assets using the detector.

6. A network-based system in accordance with claim 1, wherein said system is further configured such that detecting physical assets predicted to have anomalies comprises:
processing the first set of fleet asset data, at the central system, with the one or more computer-executable steps for detection of predicted anomalies;
generating, at the central system, with the one or more computer-executable steps for detection of predicted anomalies, hypotheses regarding the condition of the assets;
testing, at the central system, with the first set of fleet asset data and a plurality of tests for the fleet of physical assets, the hypotheses; and
determining, at the central system, whether the physical asset is predicted to be anomalous, normal, or indeterminate.

7. A network-based system in accordance with claim 6, wherein said system is further configured such that detecting physical assets predicted to have anomalies further comprises:
generating, at the central system, a plurality of methods to test the hypotheses, the plurality of methods includes at least one of:
machine learning, and
creating an expert data model; and
applying, at the central system, the plurality of methods to test the hypotheses.

8. A computer-implemented method for determining anomaly conditions within a fleet of physical assets, said method performed by a central system having at least one computing device, the computing device including a processor and a memory device coupled to the processor, said method comprising:
receiving, at the central system, a first set of fleet data from at least one data repository, the first set of fleet data substantially representative of fleet asset condition signals that are substantially representative of conditions associated with the fleet of physical assets;
generating, at the central system, using the first set of fleet data, one or more computer-executable steps for detection of predicted anomalies for each asset of the fleet of physical assets;
receiving, at the central system, a first set of fleet asset data from the at least one data repository, the first set of fleet asset data substantially representative of individual asset condition signals associated with a particular asset associated with the fleet of physical assets; and
detecting, at the central system, using the one or more computer-executable steps for detection of predicted anomalies and the first set of fleet asset data, at least one physical asset from the fleet of physical assets predicted to have at least one anomaly.

9. The method of claim 8, wherein said fleet asset condition signals are substantially representative of at least one of a plurality of signal states associated with detecting an anomaly in the fleet of physical assets.

10. The method of claim 8, wherein said receiving a first set of fleet data comprises:
receiving a first set of fleet data at the central system from the at least one data repository wherein the received first set of fleet data is one of incomplete or partially complete;
generating estimated fleet data comprises estimating the fleet data not received based upon previously received fleet data; and
incorporating the estimated fleet data with the received fleet data.

11. The method of claim 8, wherein said generating one or more computer-executable steps for detection of predicted anomalies comprises:
selecting, at the central system, a plurality of categories of state signals associated with an anomaly associated with a physical asset;
creating, at the central system, a trained predictor, the trained predictor substantially representative of a method of determining a future set of state signals based upon a present set of state signals for each asset in the fleet of physical assets; and
generating, at the central system, using the trained predictor and the first set of fleet data, the future set of state signals based upon the present set of state signals for a physical asset.

12. The method of claim 8, wherein said generating a method for detection of predicted anomalies further comprises:
creating, at the central system, a detector, the detector substantially representative of a method of identifying, based upon the future set of state signals, assets predicted to be anomalous, normal, or indeterminate; and
configuring the detector, at the central system, configuring the detector substantially representative of processing present set of state signals and future set of state signals for each asset of the fleet of assets using the detector.

13. The method of claim 8, wherein said detecting physical assets predicted to have anomalies comprises:
processing the first set of fleet asset data, at the central system, with the one or more computer-executable steps for detection of predicted anomalies;
generating, at the central system, with the one or more computer-executable steps for detection of predicted anomalies, hypotheses regarding the condition of the assets;
testing, at the central system, with the first set of fleet asset data and a plurality of tests for the fleet of physical assets, the hypotheses; and
determining, at the central system, whether the physical asset is predicted to be anomalous, normal, or indeterminate.

14. The method of claim 13, wherein detecting physical assets predicted to have anomalies further comprises:
generating, at the central system, a plurality of methods to test the hypotheses, the plurality of methods includes at least one of:
machine learning, and
creating an expert data model; and
applying, at the central system, the plurality of methods to test the hypotheses.

15. A computer for determining anomaly conditions within a fleet of physical assets, said computer associated with a database, said computer comprising a processor and a memory device coupled to the processor, said processor programmed to:
receive a first set of fleet data from at least one data repository, the first set of fleet data substantially representative of fleet asset condition signals substantially representative of conditions associated with the fleet of physical assets;
generate, using the first set of fleet data, one or more computer-executable steps for detection of predicted anomalies for each asset of the fleet of physical assets;
receive a first set of fleet asset data from at least one data repository, the first set of fleet asset data substantially representative of state signals associated with a particular asset associated with the fleet of physical assets; and
detect, using the one or more computer-executable steps for detection of predicted anomalies and the first set of fleet asset data, at least one physical asset from the fleet of physical assets predicted to have at least one anomaly.

16. The computer of claim 15, wherein said fleet asset condition signals are substantially representative of at least one of a plurality of signal states associated with detecting an anomaly in the fleet of physical assets.

17. The computer of claim 15, wherein said computer is further configured such that receiving a first set of fleet data comprises:
receiving a first set of fleet data at the central system from the at least one data repository wherein the received first set of fleet data is one of incomplete or partially complete;
generating estimated fleet data comprises estimating the fleet data not received based upon previously received fleet data; and
incorporating the estimated fleet data with the received fleet data.

18. The computer of claim 15, wherein said computer is further configured such that generating one or more computer-executable steps for detection of predicted anomalies comprises:
selecting, at the central system, a plurality of categories of state signals associated with an anomaly associated with a physical asset;
creating, at the central system, a trained predictor, the trained predictor substantially representative of a method of determining a future set of state signals based upon a present set of state signals for each asset in the fleet of physical assets; and
generating, at the central system, using the trained predictor and the first set of fleet data, the future set of state signals based upon the present set of state signals for a physical asset.

19. The computer of claim 15, wherein said computer is further configured such that generating a method for detection of predicted anomalies further comprises:
creating, at the central system, a detector, the detector substantially representative of a method of identifying, based upon the future set of state signals, assets predicted to be anomalous, normal, or indeterminate; and
configuring the detector, at the central system, configuring the detector substantially representative of processing present set of state signals and future set of state signals for each asset of the fleet of assets using the detector.

20. The computer of claim 15, wherein said computer is further configured such that detecting physical assets predicted to have anomalies comprises:
processing the first set of fleet asset data, at the central system, with the one or more computer-executable steps for detection of predicted anomalies;
generating, at the central system, with the one or more computer-executable steps for detection of predicted anomalies, hypotheses regarding the condition of the assets;
testing, at the central system, with the first set of fleet asset data and a plurality of tests for the fleet of physical assets, the hypotheses; and
determining, at the central system, whether the physical asset is predicted to be anomalous, normal, or indeterminate.
